(19) United States
(12) Patent Application Publication
(10) Pub. No.: US 2026/0287059 A1
(43) Pub. Date: Sep. 24, 2026

(54) CHAIN PIN SEAL FOR A CHAIN TO BE USED IN CONVEYOR AND/OR DRIVE TECHNOLOGY

(71) Applicant: Carl Freudenberg KG, Weinheim (DE)

(72) Inventors: Hartmut NÄSER, Schwalmstadt (DE); Gonzalo BARILLAS, Alsfeld-Altenburg (DE)

(21) Appl. No.: 19/568,979

(22) Filed: Mar. 17, 2026

(30) Foreign Application Priority Data
Mar. 20, 2025 (DE) 10 2025 110 747.5

(51) Int. Cl. F16J 15/3236; B65G 17/38; F16G 13/06; F16J 15/3284

(52) U.S. Cl. CPC F16J 15/3236; B65G 17/38; F16G 13/06; F16J 15/3284

(57) ABSTRACT

A chain pin seal for a chain to be used in conveyor and/or drive technology includes a sealing region and a supporting region, where the chain pin seal has a symmetrical cross section. The sealing region includes at least two sealing lips each having at least one sealing edge projecting from the sealing lip. The sealing region and the supporting region are formed in one piece and of one and the same material.

### CROSS REFERENCE TO RELATED APPLICATIONS

This application claims benefit to German Patent Application No. DE 10 2025 110 747.5, filed on March 20, 2025, which is hereby incorporated by reference herein.

### FIELD

The invention relates to a chain pin seal for a chain to be used in conveyor and/or drive technology, the chain pin seal having a sealing region and a supporting region, the sealing region and the supporting region being formed in one piece and of one and the same material, the chain pin seal being symmetrical in a cross section.

### BACKGROUND

Chain pin seals are used for chains that are used in particular in the fields of materials handling and conveyor technology, for conveyor belts, drive chains, chain pulleys, and bucket chains, and in quarrying and mining. In these fields of application, the atmosphere contains increased levels of dust and dirt. The chains used therein usually comprise an outer chain link, an inner chain link, a chain pin, and a pivot bush. The chain pin interconnects chain links, i.e., connects outer chain links to inner chain links.

To ensure that outer chain links and chain pins can rotate relative to inner chain links and pivot bushes, lubricants, for example oil or grease, are added to make the rotational movement easier, to reduce mechanical abrasion of the components at the contact surfaces, and thus to extend the service life of the chains. To ensure that the lubricant required for the lubrication is kept between the chain pin and the pivot bush, chain pin seals are installed on the chain pin. First, this is to prevent lubricant from escaping into and contaminating the surrounding area. Second, this is to prevent dirt particles from getting in between the chain pin and the pivot bush and adversely affecting the functioning of the chain.

The sealing function of known chain pin seals is based on a dynamic-sealing element made of hard material and a resilient element made of elastomer material, which compensates for tolerances, wear, and material relaxation. A metal ring for stability can also be included. Chain pin seals of this kind are formed in multiple parts and are known, for example, from US 8,985,590 B2.

### SUMMARY

In an embodiment, the present disclosure provides a chain pin seal for a chain to be used in conveyor and/or drive technology that includes a sealing region and a supporting region, where the chain pin seal has a symmetrical cross section. The sealing region includes at least two sealing lips each having at least one sealing edge projecting from the sealing lip. The sealing region and the supporting region are formed in one piece and of one and the same material.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a sectional view of a chain pin seal;

FIG. 2 is a sectional view of a sealing arrangement for a chain, comprising a chain pin seal according to FIG. 1; and

FIG. 3 is a perspective view of a chain portion comprising a sealing arrangement according to FIG. 2.

### DETAILED DESCRIPTION

An embodiment of the present disclosure provides a chain pin seal which exhibits improved ease of handling and improved sealing action. Embodiments of the present disclosure provide a sealing arrangement, a chain, and a use of a chain pin seal, which exhibit improved ease of handling and improved sealing action.

An embodiment of the present disclosure includes a chain pin seal for a chain to be used in conveyor and/or drive technology has a sealing region and a supporting region, the sealing region and the supporting region being formed in one piece and of one and the same material, the chain pin seal being symmetrical in cross section, the sealing region having at least two sealing lips, each having at least one sealing edge projecting from the sealing lip.

The chain pin seal is formed annularly around a longitudinal axis, the longitudinal axis being arranged in a centered manner in relation to the chain pin seal. The chain pin seal is formed axially symmetrically in relation to a radial plane, the longitudinal axis running orthogonally to the radial plane. The radial plane thus runs centrally through the chain pin seal. In cross section, therefore, the chain pin seal is formed symmetrically in relation to the radial plane. The axial symmetry makes installing the chain pin seal considerably simpler and avoids the risk of mounting errors due to mistakes relating to the installation direction. In this respect, the ease of handling can be improved. The chain pin seal is used for chains in the fields of materials handling, conveyor technology, conveyor belts, bucket chains, and mining, and, according to the present disclosure, is formed in one piece and of one and the same material. Since the sealing region, the supporting region, and the chain pin seal are formed in one piece and of one and the same material, the chain pin seal consists of a single component. This reduces the time required for the mounting process since there is no need to assemble a plurality of individual components of the chain pin seal. At the same time, the one-piece configuration increases the reliability of the mounting process since erroneous assembling of the chain pin seal is avoided.

The supporting region may be formed as a main body, and the sealing lips may project from the main body. Preferably, the main body is formed solidly and has a supporting function, the sealing lips having a sealing function. A first subset of sealing lips is arranged radially internally and a second subset of sealing lips is arranged radially externally in relation to the main body, the radially internally arranged sealing lips projecting substantially radially inward, and the radially externally arranged sealing lips projecting substantially radially outward. If there are four sealing lips, two sealing lips are arranged radially internally and two sealing lips are arranged radially externally in relation to the main body.

The sealing region may have four sealing lips, the sealing lips each having sealing edges, the sealing edges being arranged in a stepwise manner. The sealing edges may be circular and be arranged concentrically around the longitudinal axis of the chain pin seal. The sealing edges may also be arranged differently around the longitudinal axis of the chain pin seal, for example in a wave-like, in particular sinusoidal, manner rather than concentrically around the longitudinal axis of the chain pin seal. This can enable a conveying action and in particular can allow lubricant to be conveyed back into the space being sealed. Preferably, each sealing lip may have two or three sealing edges. Particularly preferably, each sealing lip may have exactly two sealing edges, meaning that the chain pin seal has four sealing lips and eight sealing edges in total. The sealing edges are arranged on each sealing lip in a manner offset radially and axially, i.e., in a stepwise manner. If there are two sealing edges per sealing lip, then the sealing edges of the second step may be arranged axially and/or radially closer to the main body of the chain pin seal than the sealing edges of the first step in the relaxed state before the chain pin seal is mounted. Then, when the chain pin seal is mounted, said sealing edges of the second step can come to abut corresponding surfaces, owing to deformation of the sealing lips. The sealing function of the chain pin seal is implemented at a plurality of points owing to the plurality of sealing edges. This redundancy in the sealing function improves the sealing action. Alternatively, if the sealing edges of the first step of a particular sealing lip become worn, the sealing edge of the second step of that sealing lip can come to abut corresponding surfaces and implement a sealing function. Overall, this can extend the service life of the chain pin seal. The region between the radially inner and radially outer sealing edges may be provided with lubricant. This can increase the operational life of the seal.

The chain pin seal may have a protruding ridge along its line of symmetry, the ridge being arranged between two sealing lips. Preferably, the ridge is arranged between the two radially outwardly projecting sealing lips. The ridge is preferably arranged radially outwardly on the chain pin seal. Preferably, the ridge is arranged on the main body. The ridge is formed as a convex bulge on the chain pin seal. The ridge reduces the interstice between the radially outwardly projecting sealing lips. As a result, the volume adjoining the main body and the sealing lips is reduced and less space is available for potential dirt particles, thereby further improving the sealing function. In particular, this can prevent larger particles that may cause damage to the sealing lips from getting into the interstice and accumulating therein.

The chain pin seal may consist of a thermoplastic polymer. Preferably, the chain pin seal may consist of a thermoplastic polyurethane. Thermoplastic polyurethanes are noted for their excellent wear performance, exceptionally high tear strength, high elasticity across the entire hardness range, and good resistance to high-energy radiation. Thermoplastic polyurethanes are also resistant to oxygen, ozone, and mineral oils and greases. By using this material, a dimensionally stable main body that simultaneously has resilient sealing lips is obtained, as a result of which the sealing function can be further improved.

An embodiment of the present disclosure includes a sealing arrangement for a chain to be used in conveyor and/or drive technology, said sealing arrangement comprising at least one outer chain link, at least one pivot bush, at least one chain pin, and an above-described chain pin seal, the chain pin seal sealing the gap between an outer chain link and a pivot bush. The sealing arrangement may further comprise an inner chain link. In this case, a chain pin interconnects chain links, i.e., each one connects outer chain links to inner chain links. Chain pin seals are installed on the chain pin to ensure that the lubricant, for example oil or grease, required for the lubrication is kept between the chain pin and the pivot bush and also to prevent the lubricant both from leaking and from being contaminated. Outer chain links, chain pins, inner chain links, and pivot bushes are arranged rotatably about a longitudinal axis of the chain pin. In this case, outer chain links and chain pins are arranged rotatably relative to inner chain links and pivot bushes. In some applications, the geometric configuration of the components does not allow the outer chain links and chain pins to fully rotate relative to inner chain links and pivot bushes, instead merely allowing them to perform a pivot movement. In other applications, however, full rotation is possible.

It is advantageously provided that the chain pin seal abuts the outer chain link and/or the pivot bush under resilient preloading. The resilient preloading presses the sealing lips by the sealing edges against the outer chain link and/or the pivot bush, thereby further improving the sealing action. Preloading of this kind is achieved by virtue of the outer chain link, the pivot bush, and the chain pin seal arranged therebetween being pressed axially together. The axial compression of the chain pin seal is absorbed by the sealing lips such that the main body of the chain pin seal is not compressed.

According to an embodiment of the present disclosure, it is provided that the sealing lips of the chain pin seal that face the outer chain link abut the outer chain link, and the sealing lips of the chain pin seal that face the pivot bush abut the pivot bush. In this case, the sealing lips abut an end face of the pivot bush. In doing so, the axially compressed sealing lips abut end faces of the pivot bush and of the outer chain link such that no dirt particles can enter the sealing arrangement and no lubricants can be lost from the sealing arrangement.

The sealing arrangement may comprise a spacer, the spacer preferably being formed annularly. Preferably, the spacer is made of a metal material. Further preferably, the spacer is made of a hard and tough material. The spacer preferably has a high hardness, the hardness being higher than the hardness of the adjoining components, in particular of the outer chain links and the pivot bush.

Preferably, the spacer is arranged between the outer chain link and the pivot bush in the axial direction. The spacer can, for example, be configured as a bush and serve as a stop for the outer chain link and the pivot bush. For this purpose, the spacer is dimensioned such that the outer chain link and the pivot bush are spaced apart from one another in the axial direction by the spacer. As a result, when the outer chain link, the chain pin seal, and the pivot bush are pressed together, the chain pin seal can only be compressed by a defined amount, namely to the axial dimension of the spacer. This can prevent damage to the chain pin seal caused by excessive compression. Moreover, the spacer is dimensioned such that the outer chain link and the pivot bush are prevented from coming into contact by their respective radial configurations.

A use of an above-described chain pin seal in a chain can be used in conveyor technology. The above-described chain pin seal may, however, also be used in a chain in the field of materials handling, for conveyor belts, drive chains, chain pulleys, and bucket chains, and in quarrying and/or mining.

A chain comprising an above-described sealing arrangement can be used in conveyor technology.

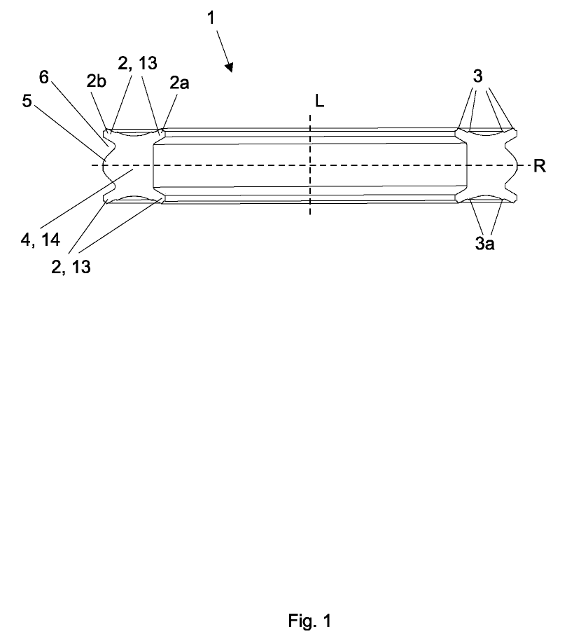

FIG. 1 is a sectional view of a chain pin seal 1, the chain pin seal 1 having a sealing region 13 and a supporting region 14, the sealing region 13 being formed as a seal and the supporting region 14 being formed as a supporting element. The sealing region 13 and the supporting region 14, and the chain pin seal 1 per se, are formed in one piece and of one and the same material.

The chain pin seal 1 is formed annularly around a longitudinal axis L. The chain pin seal 1 is formed axially symmetrically in relation to a radial plane R, the longitudinal axis L running orthogonally to the radial plane R, and the radial plane R running centrally through the chain pin seal 1.

The supporting region 14 is formed as a main body 4, and the sealing lips 2 project from the main body 4. The main body 4 forming the supporting region 14 is formed solidly out of solid material and has a supporting function. The sealing lips 2 forming the sealing region 13 have a sealing function.

The sealing region 13 has four sealing lips 2. Two sealing lips 2a are arranged radially internally and two sealing lips 2b are arranged radially externally in relation to the main body 4, the radially internally arranged sealing lips 2a projecting substantially radially inward, and the radially externally arranged sealing lips 2b projecting substantially radially outward.

The sealing lips 2 each have two sealing edges 3. Thus, the chain pin seal 1 has four sealing lips 2 and eight sealing edges 3 in total. The sealing edges 3 are arranged in a stepwise manner. In this embodiment, the sealing edges 3 are arranged in a circular manner and concentrically around the longitudinal axis L of the chain pin seal 1. In an alternative embodiment, the sealing edges 3 may be arranged differently around the longitudinal axis L of the chain pin seal 1, for example in a wave-like, in particular sinusoidal, manner rather than concentrically around the longitudinal axis L of the chain pin seal 1. The sealing edges 3 are arranged on each sealing lip 2 in a manner offset radially and axially, i.e., in a stepwise manner. The sealing edges 3a, which are each arranged at an offset, are arranged axially and/or radially closer to the main body 4 of the chain pin seal 1 in the relaxed state before the chain pin seal 1 is mounted. When the chain pin seal 1 is mounted, each of said sealing edges 3a arranged closer to the main body 4 comes to abut corresponding surfaces, owing to deformation of the sealing lips 2. The sealing function of the chain pin seal 1 is implemented at a plurality of points owing to the plurality of sealing edges 3.

The chain pin seal 1 has a protruding ridge 5 along its line of symmetry (i.e., the radial plane R), the ridge 5 being arranged between two sealing lips 2. The ridge is arranged between two radially outwardly projecting sealing lips 2. The ridge 5 is arranged radially outwardly on the chain pin seal 1. The ridge 5 is formed as a convex bulge on the chain pin seal 1. The ridge 5 reduces the clearance 6 between the radially outwardly projecting sealing lips 2.

The chain pin seal 1 consists of a thermoplastic polymer, more specifically of a thermoplastic polyurethane.

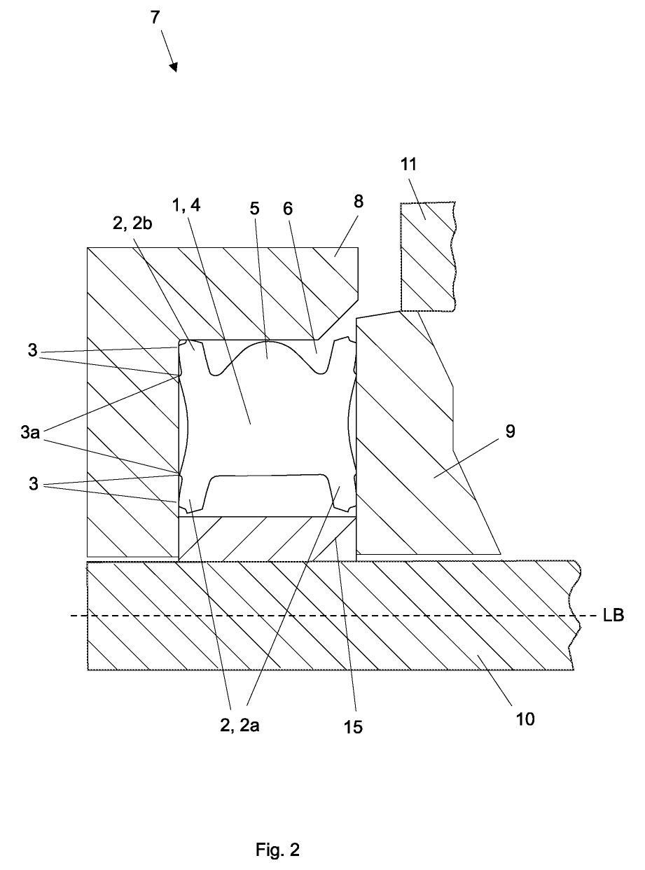

FIG. 2 is a sectional view of a sealing arrangement 7 comprising an outer chain link 8, a pivot bush 9, a chain pin 10, a spacer 15, and a chain pin seal 1 shown in FIG. 1. The chain pin seal 1 seals the gap between the outer chain link 8 and the pivot bush 9. The sealing arrangement 7 further comprises an inner chain link 11. The sealing arrangement 7 is part of a chain 12; for ease of illustration, the inner chain link 8, pivot bush 9, and chain pin 10 have each only been shown in part. The chain pin 10 connects the outer chain link 8 to the inner chain link 11. Outer chain links 8, chain pins 10, inner chain links 11, and pivot bushes 9 are arranged rotatably about a longitudinal axis LB of the chain pin 10. In this case, the outer chain link 8 and the chain pin 10 are arranged rotatably relative to the inner chain link 11 and the pivot bush 9, the geometric configuration of the components enabling a pivot movement rather than full rotation.

The chain pin seal 1 abuts the outer chain link 8 and the pivot bush 9 under resilient preloading. The resilient preloading presses the sealing lips 2 by the sealing edges 3 against the outer chain link 8 and the pivot bush 9, thereby further improving the sealing action. Preloading of this kind is achieved by virtue of the outer chain link 8, the pivot bush 9, and the chain pin seal 1 arranged therebetween being pressed axially together. The axial compression of the chain pin seal 1 is absorbed by the sealing lips 2 such that the main body 4 of the chain pin seal 1 is not compressed.

The sealing lips 2 of the chain pin seal 1 that face the outer chain link 8 abut the outer chain link 8, and the sealing lips 2 of the chain pin seal 1 that face the pivot bush 9 abut the pivot bush 9. In doing so, the axially compressed sealing lips 2 abut end faces of the pivot bush 9 and of the outer chain link 8 such that no dirt particles can enter the sealing arrangement 7 and no lubricants can be lost from the sealing arrangement 7.

The sealing arrangement 7 comprises a spacer 15, the spacer 15 being formed annularly. The spacer 15 is made of a hard and tough metal material. The spacer 15 has a high hardness, the hardness being higher than the hardness of the adjoining components – the outer chain link 8 and the pivot bush 9.

The spacer 9 is arranged between the outer chain link 8 and the pivot bush 9 in the axial direction and radially below the chain pin seal 1. The spacer 15 is configured as a bush and serves as a stop for the outer chain link 8 and the pivot bush 9. For this purpose, the spacer 15 is dimensioned such that the outer chain link 8 and the pivot bush 9 are spaced apart from one another in the axial direction by the spacer 15. As a result, when the outer chain link 8, the chain pin seal 1, and the pivot bush 9 are pressed together, the chain pin seal 1 can only be compressed by a defined amount, namely to the axial dimension of the spacer 15. This can prevent damage to the chain pin seal 1 caused by excessive compression. Moreover, the spacer 15 is dimensioned such that the outer chain link 8 and the pivot bush 9 are prevented from coming into contact by their respective radial configurations.

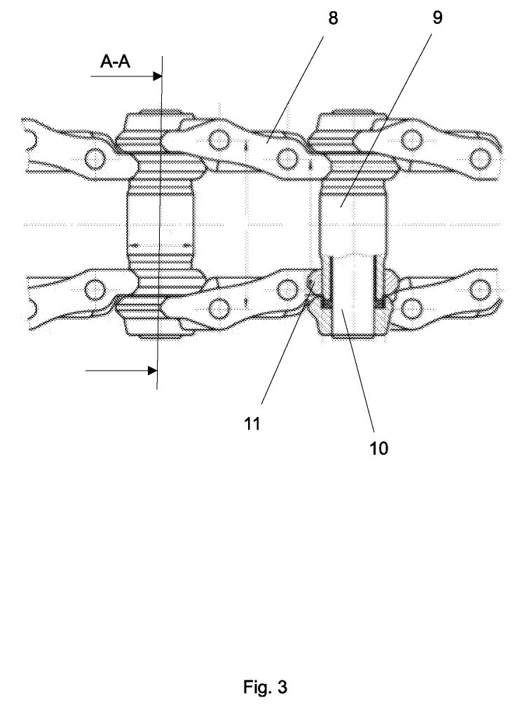

FIG. 3 shows a chain 12 comprising a sealing arrangement shown in FIG. 2. The chain pin seal 1 of the sealing arrangement is not visible owing to the installation situation in FIG. 3. The sectional view of FIG. 2 is in the sectional plane A-A shown in FIG. 3.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A chain pin seal for a chain to be used in conveyor and/or drive technology, the chain pin seal having a symmetrical cross section and comprising:
a sealing region comprising at least two sealing lips each having at least one sealing edge projecting from the sealing lip; and
a supporting region, wherein the sealing region and the supporting region are formed in one piece and of one and the same material.

2. The chain pin seal according to claim 1, wherein the supporting region is formed as a main body, and wherein the at least two sealing lips project from the main body.

3. The chain pin seal according to claim 1, wherein the sealing region comprises four sealing lips, wherein the four sealing lips each have two sealing edges, and wherein the two sealing edges are arranged in a stepwise manner.

4. The chain pin seal according to claim 1, wherein the chain pin seal has a protruding ridge along its line of symmetry, the protruding ridge being arranged between the at least two sealing lips.

5. The chain pin seal according to claim 1, further comprising a thermoplastic polymer.

6. A sealing arrangement for a chain to be used in conveyor and/or drive technology, the sealing arrangement comprising:
at least one outer chain link;
at least one pivot bush;
at least one chain pin; and
a chain pin seal according to claim 1, wherein the chain pin seal seals a gap between the at least one outer chain link and the at least one pivot bush.

7. The sealing arrangement according to claim 6, wherein the sealing arrangement further comprises a spacer, wherein the spacer is formed annularly, and wherein the spacer is arranged between the at least one outer chain link and the at least one pivot bush in an axial direction.

8. The sealing arrangement according to claim 6, wherein the sealing arrangement further comprises an inner chain link.

9. The sealing arrangement according to claim 6, wherein the chain pin seal abuts the at least one outer chain link and/or the at least one pivot bush under resilient preloading.

10. The sealing arrangement according to claim 9, wherein the sealing lips of the chain pin seal that face the at least one outer chain link abut the at least one outer chain link, and the sealing lips of the chain pin seal that face the at least one pivot bush abut the at least one pivot bush.

11. A chain to be used in conveyor and/or drive technology, comprising a sealing arrangement according to claim 6.

12. The chain pin seal according to claim 1, further comprising a thermoplastic polyurethane.
